(19) United States
(12) Patent Application Publication
(10) Pub. No.: US 2017/0142098 A1
(43) Pub. Date: May 18, 2017

(54) One-Time Password Key Systems and Methods

(71) Applicant: Mark Nataros, Austin, TX (US)

(72) Inventor: Mark Nataros, Austin, TX (US)

(21) Appl. No.: 15/350,048

(22) Filed: Nov. 12, 2016

Related U.S. Application Data
(60) Provisional application No. 62/254,691, filed on Nov. 12, 2015.

(51) Int. Cl. H04L 29/06

(52) U.S. Cl. CPC H04L 63/0838; H04L 63/061

(57) ABSTRACT

A system that includes a client front end, a client server, and an authentication server, wherein the client server transfers a unique one-time password key to the authentication server. Upon a successful authentication of the client front end, the authentication server transfers the one-time password key thereto, thereby enabling the client front end to employ the one-time password key to initiate a communication channel with the client server.

### STATEMENT OF PRIORITY

The present application claims priority to U.S. Provisional Application No. 62/254,691, titled “One-Time Password Key Systems and Methods” and filed Nov. 12, 2015.

### TECHNICAL FIELD

The present disclosure relates to employing a one-time password key as a method of communication instantiation between computers.

### BACKGROUND

When initiating communications between a client device and a server, some form of login and authentication is almost always required. Such may be the simple method of a user at the client console or station simply inputting a username and password, which is verified by the server, thereby enabling the user to access data stored thereon.

A similar method employs a “token” the user has in their possession which typically has a 6 (or more) digit code to be used in combination with the user's login in order to gain access to the server. The token provides increased security as the token code is constantly changing, for example, every 30 or 60 seconds. The server is synchronized with the token and includes the same algorithm, thereby knowing what code to expect at any given time. However, such technology still has downfalls. For example, the user is forced to always have the token on them, however the token is usually a small device that can easily be lost or stolen. Additionally, while difficult, it is still possible to obtain knowledge of the algorithm used to generate the token code, and therefore possible to “hack” a user's login.

Further methods of login involve one-time password keys, where a password may only be used once before being marked as invalid. Security of such a method results from no password ever being used twice, therefore enabling one to hack or determine the password, but the password no longer being valid after the initial use. This method as well presents problems, such as typically requiring a password file on both the client and server systems. Moreover, such a file is typically very large in size (e.g., 1 Gigabyte or more), thereby consuming hard drive space, especially if such is being stored on a portable device (e.g., tablet, iPad, etc.) or a mobile device, which typically have far less hard drive space than a regular desktop computer. Additionally, this leads to the possibility the entire file can be lost, stolen, or hacked.

Accordingly, improved systems and methods for user login authentication remain highly desirable.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is an authentication and data sharing system, according to one or more embodiments.

FIG. 2 is a block diagram of a computing device, according to one or more embodiments.

### DETAILED DESCRIPTION

The present disclosure relates to instantiating a connection between two computers and, more specifically, ensuring authentication via a one-time password key verification system. In one embodiment, the present disclosure includes a system that employs a client server installed with software which a user desires to use, and which transfers a one-time password key to an authentication server. The system further includes a client front end which the user logs into and desires to connect to the client server to use the software thereon. The client front end is authenticated by an authentication server, which, upon authentication, passes the one-time password key to the client front end for passing to the client server as verification of authentication.

Advantageously, the one-time password key is only valid for a single login attempt to the client server, thus unauthorized obtainment or use of the key is fruitless as the key will no longer work due to being invalid. Moreover, a new key is automatically generated by the client server after each session is complete, thereby not requiring a license file of predetermined keys. In other words, the client server “re-registers” with the authentication server after each connection ends, thereby transferring a new one-time password key thereto.

As used herein, a “processor” may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art.

As used herein, “memory” may be any type of storage or memory known to those skilled in the art capable of storing data and/or executable instructions. Memory may include volatile memory (e.g., RAM), non-volatile memory (e.g., hard-drives), or a combination thereof. Examples of such include, without limitation, all variations of non-transitory computer-readable hard disk drives, inclusive of solid-state drives. Further examples of such may include RAM external to a computer or controller or internal thereto (e.g., “on-board memory”). Example embodiments of RAM may include, without limitation, volatile or non-volatile memory, DDR memory, Flash Memory, EPROM, ROM, or various other forms, or any combination thereof generally known as memory or RAM. The RAM, hard drive, and/or controller may work in combination to store and/or execute instructions.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

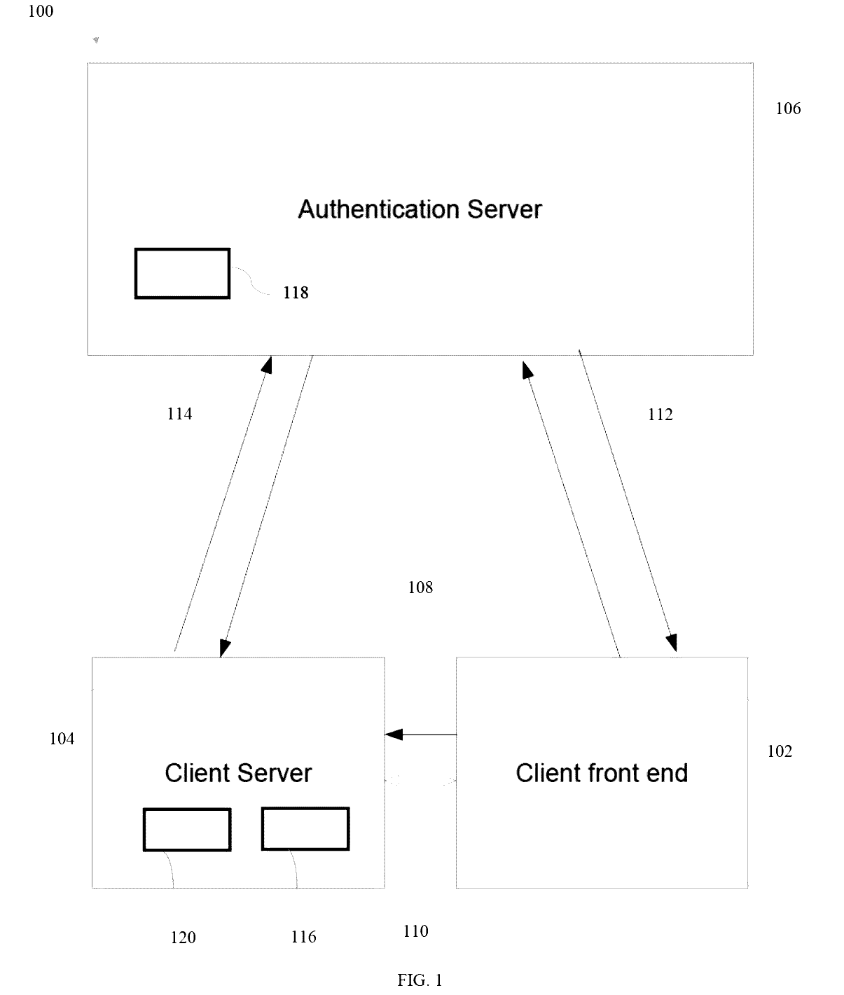

FIG. 1 depicts an authentication and data sharing system 100, according to one or more embodiments. As depicted, the system 100 includes a client front end 102, a client server 104, and an authentication server 106. For example and without limitation, the client front end 102 may be a desktop computer, or may be a more portable computing device, such as a laptop, tablet, iPad, cellular telephone, or the like. The client server 104 host is the primary computer in which the client front end 102 communicates with. The client server 104 may be any type of server known to those skill in the art, including but not limited to, a desktop server, blade server, or cloud computing network. The authentication server 106, detailed below, is responsible for initially configuring communication between the client front end 102 and the client server 104, including receiving one-time password keys from the client server 104 and passing such along to the client front end 102 to then use when initiating communication with the client server 104. Similar to the client server 104, the authentication server 106 may be, for example and without limitation, a desktop server, blade server, or cloud computing network. Moreover, in some embodiments, the authentication server 106 may be a separate computer from the client server 104, while in other embodiments, the client server 104 and the authentication server 106 may be hosted or run on the same server hardware.

While FIG. 1 depicts an embodiment containing only a single client front end 102, client server 104, and authentication server 106, such should not be construed as limiting. One of skill in the art will readily appreciate that other embodiments of the system 100 may include numerous client front ends 102, client servers 104, and/or authentication servers 106.

The client front end 102 is communicably coupled to the client server 104 via a first communication channel 108 as established via a one-time password key, discussed in further detail below. Upon a successful connection with the client server 104, a pipe or data stream 110 is established therebetween which transfers a substantial majority of the data. The client front end 102 is further communicably coupled to the authentication server 106 via a second communication channel 112. The client front end 102 requests an available client server 104 from the authentication server 106. Upon determination of which client server 104 is available, the authentication server 106 transfers a “one-time password key” associated with the available client server 104 to the client front end 102 via the second communication channel 112. The client front end 102 can then use the one-time password key to access the client server 104. The system 100 further includes a third communication channel 114 between the authentication server 106 and the client server 104. The third communication channel 114 can be used to register the client server 104 with the authentication server 106, for the authentication server 106 to send licenses to the client server 104, and for the client server 104 to send its one-time password key to the authentication server 106.

In one exemplary operation, after the authentication server 106 has booted up and after the client server 104 has booted up, a secure connection is established therebetween via the third communication channel 114. During or shortly after the established connection, the client server 104 may communicate information to the authentication server 106, such as the client server's 104 specifications, unique ID, or other information enabling the authentication server 106 to recognize the client server 104. The client server 104 also sends the authentication server 106 the one-time password key 116, discussed below. The authentication server 106 takes this information and may determine a particular set or subset of client front ends 102 which will be allowed to connect to the client server 104.

The client front end 102 also connects to the authentication server 106, doing so via the second communication channel 112. In one embodiment, the client front end 102 sends information to the authentication server 106 such as a user name and login password. Upon approval of the client front end 102 credentials, the authentication server 106 may return a list of client servers 104 available which the client front end 102 may use. The client front end 102 (or user thereof) selects which client server 104 they so desire to use, and such a selection is returned to the authentication server 106. The authentication server 106 then sends the one-time password key 116 associated with that client server 104 to the client front end 102, where the client front end 102 then further transfers the one-time pass key 116 to the client server 104, thereby authenticating and/or allowing the client front end 102 to login, gain access, and/or take control of the client server 104.

In the process of the client front end 102 establishing a connection with the client server 104, the client server 104 also obtains a license from the authentication server 106. In one embodiment, such may be securely accomplished via a “reverse” RSA methodology. While RSA is a known encryption technique to those skilled in the art, the system 100 may employ a “reverse” RSA methodology, wherein the authentication server 106 has stored thereon a public key 118 used for encryption, and the one or more client server(s) 104 includes a private key 120 used for decryption.

Such a methodology ensures that the license was actually generated by the authentication server 106 (or, in other words, that only the authentication server is capable of sending the license). With the reverse RSA implementation, even if an unauthorized user obtains the private decryption key, and is therefore capable of decrypting the license, such is meaningless and fails to provide an advantage as they are still unable to generate or mimic an encrypted license as generated by the authentication server, and thus the software of the client server will not operate.

In one embodiment, the license is time-based, wherein the license is valid between a particular date and time. For example, a license may be valid from 2 pm UTC to 3 pm UTC time on a particular day. The client server 104 periodically attempts to obtain a new license from the authentication server 106 prior to expiration of the current license. However, advantageously, failure to obtain a renewed license on the initial attempts does not shut down the client server 104. Continuing from the previous example, if the current license is valid from 2 pm UTC to 3 pm UTC, the client server 104 may initially request a renewed license from the authentication server 106 at 1:15 pm UTC. If such a request fails, for example, because the authentication server is offline for maintenance, the client server 104 continues to run because the current license key is still valid until 3 pm UTC. Multiple additional attempts can be made for the client server 104 to attempt to obtain a renewed license. Only if the current license expires before renewed will the client server 104 shut down and cease to operate.

Advantageously, in some embodiments, a new one-time password key 116 is generated by the client server 104 upon the disconnection of the current session with a client front end 102. Moreover, in another embodiment, upon the client front end 102 indicating to the authentication server 106 which client server 104 it desires a connection to, the authentication server 106 “locks,” indicates, or otherwise deems that particular client server 104 as unavailable to any other client front end 102 so that no two client front ends 102 have the same one-time password key 116, as only the first client front end 102 would be allowed access to the client server 104, and all others would be denied access because their one-time password key 116 is now invalid.

In further embodiments, for example, if the one-time password key 116 is not used by the client front end 102 within a predetermined amount of time, or the first communication channel 108 otherwise fails, the process begins over again with the client server 104 sending a new one-time password key 116 to the authentication server 106, and the authentication server 106 “unlocks” or otherwise indicates that the client server 104 is again available for a client front end 102 to select.

In further embodiments, upon a successful initiation of the first communication channel 108, the client front end 102 may transfer unique system information to the client server 104. Such system information may include, for example and without limitation, the client front end 102 IP address, MAC address, system location, and/or the like.

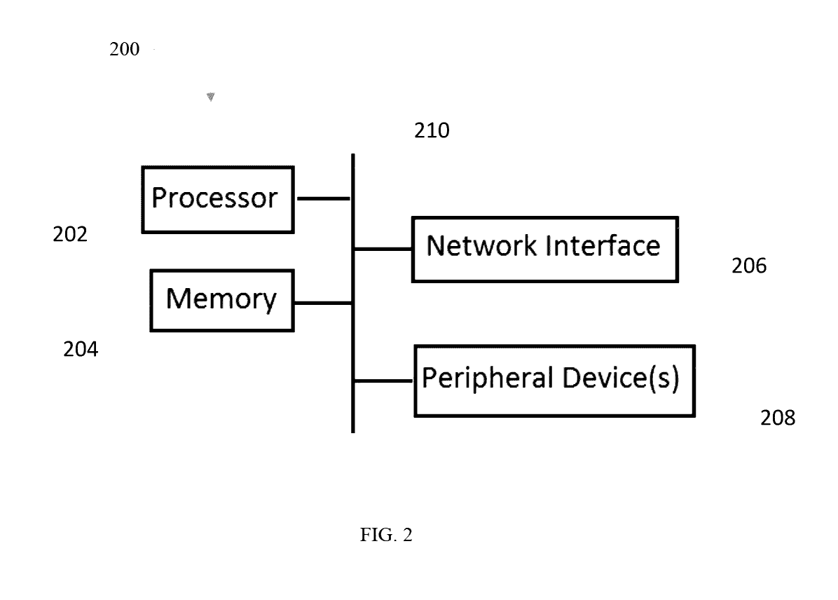

FIG. 2 depicts a block diagram 200 of a computing device that may be employed as one or more of the client front end 102, client server 104, and/or authentication server 106, according to one or more embodiments. In the embodiment depicted, the diagram 200 includes a processor 202, a memory 204, a network interface 206, and one or more peripheral device(s) 208.

The processor 202 may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art. Thus, the processor 202 may be comprised of a central processing unit (CPU) and an accelerated processing unit (APU) or graphics processing unit (GPU), thereby enabling increased ability to perform graphics processing.

The block diagram 200 further includes various types of memory 204, such as a hard drive and/or random access memory (RAM). Hard drive(s) may be any type of memory known to those skilled in the art capable of storing data or executable instructions thereon for a prolonged period of time, and continuing to store such should power to the computer (e.g., the client front end 102, client server 104, or authentication server 106) be turned off. Examples of such include, without limitation, all variations of non-transitory computer-readable hard disk drives, inclusive of solid-state drives. Other embodiments of the memory 204 may alternatively or additionally include random access memory (RAM). RAM may be external to computer, or in other embodiments be internal (e.g., “on-board” memory) to computer, and work in coordination with any hard drive to store and/or execute programs and/or process graphics data, etc. Example embodiments of RAM may include, without limitation, volatile or non-volatile memory, DDR memory, Flash Memory, EPROM, ROM, or various other forms, or any combination thereof generally known as memory or RAM.

The network interface 206 may be any interface capable of sending and receiving data via a network. Examples may include, but are not limited to, hard-wired network interface card(s) (NIC), and/or wireless network interfaces, including those capable of transmitting data over a cellular provider network. The network interface 206 may be configured to communicate over one or more of a local area network (LAN), wide area network (WAN), cellular provider network (or “mobile network”), along with “cloud” networks.

The peripheral device(s) 208 may include, for example and without limitation, a keyboard, mouse, and/or display. For example, the client server 104 and authentication server 106, which, in at least one embodiment are hosted on the same computer, may initially be configured or updated via a locally connected mouse, keyboard, and/or monitor. Alternatively, such may be remotely configured, for example, via a remote login over a network. The client front end 102 may vary from a desktop computer, to a portable computing device such as a laptop, tablet, iPad, etc, to a cellular device. Therefore, in some embodiments, the peripheral device 208 may include a touch screen display or embedded display (e.g., mobile devices).

One or more of the processor 202, memory 204, network interface 206, and peripheral device(s) 208 are communicably coupled via one or more busses 210.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of” or “consist of” the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A system/method for secure authentication between systems or nodes to prevent unauthorized connections or access.

2. A method of claim 1, further comprising: A use of a network interface (such as described in 0029) or non-network (such as local same system) communication to transfer this One Time Pass Key (also known as a One Time Use Password Key).

3. A method of claim 1, further comprising: Generating a secure key of sufficient length to prevent unwanted access.

4. A method of claim 1, further comprising: Sharing the generated key in a secure fashion (Such as an RSA encrypted transmission used only to provide the key to the client at the time of log in, or a known ‘bank’ of keys securely stored locally to prevent the need for real-time transmission of the One Time Key outside of its one log in attempt use, etc.).

5. A method of claim 1, further comprising: Using the shared key once for authenticated access.

6. A method of claim 1, further comprising: Disregarding any access attempts made without the proper One Time Pass Key, and optionally regenerating the One Time Pass key after a number (1 to many to never) of failed access attempts or upon the disconnection of the current session with a client front end or proper use of the One Time Pass key (as the key may only be used one).
